(19) United States
(12) Patent Application Publication
(10) Pub. No.: US 2005/0045368 A1
(43) Pub. Date: Mar. 3, 2005

(54) Dual layer wire and cable

(76) Inventor: Michael John Keogh, Pinehurst, NC (US)

Correspondence Address: Michael John Keoga, 19 ABINGTON DRIVE, PINEHURST, NC, 28374, US

(21) Appl. No.: 10/653,678

(22) Filed: Sep. 2, 2003

(51) Int. Cl. H01B 7/00

(52) U.S. Cl. 174/120 R

(57) ABSTRACT

Non-halogen wire and cable dual layer constructions with high levels of flame retardance useful as sheaths or insulations

### BACKGROUND—FIELD OF INVENTION

The present invention relates to protection of wires and cables used in buildings and transit and more particularly to fire and thermal protection of the wire and cables used in these applications.

### BACKGROUND—DESCRIPTION OF PRIOR ART

Wire and cable materials installed in buildings do not represent a major quantity of the flammable material (fire load) in a building. However because they are installed concealed in ceilings, floors and walls and connected via shafts and raceways they do present a major hazard to persons and equipment. During a fire event these shafts and raceways provide for easy transport of flame, smoke and toxic and corrosive gases throughout a building. For this reason the National Electrical Code (NEC) sets requirements that limit the flame spread and combustion gases from burning wires and cables in buildings.

Polyolefin resins, particularly polyethylene and polypropylene, are superior materials for wire and cable building application in all respects except flammability. Technology to add flame retardance, involving both halogen additives and non-halogen additives, has been developed. When these approaches are employed to improve the flame resistance of polyolefins serious compromises in the overall performance of the system result.

The disadvantages of the halogen additive approach are reduced electrical performance of the material and increased smoke and toxic and corrosive gases on combustion. Moreover, even when employed at relatively low levels, halogen flame retardants significantly add to compound cost.

The non-halogen additive approach also reduces electrical performance but does not compromise the combustion advantages. However because significant flame retardance is only acquired with the addition of high levels of metal salts, such as, aluminum and magnesium hydrates, the formulated products have higher costs, process more slowly and have somewhat reduced physical and mechanical properties when compared with the original non-flame retarded polyolefin base resin. Moreover under certain test conditions, for example for plenum cable, even the most highly filled polyolefin resin components fail to pass the flame spread requirement. Metal hydrate flame protection depends on an endothermic heat sink mechanism. Riser and plenum cable test methods involve prolonged test times at high temperatures. This combination exhausts the endothermic flame retardant, raises the temperature of the cable and leads to rapid flame spread along the cable.

The art is constantly seeking to develop materials for use in wire and cable applications to replace halogen-based flame retarded (FR) systems for their substantial disadvantages of toxic and corrosive combustion by-products. Non-halogen metal hydrate FR polyolefins overcome these combustion by-product disadvantages and are finding use in many but not all application areas. As previously mentioned, in applications such as riser and plenum, the flame retardance provided by the metal hydrates is not always adequate. Moreover in applications such as transit and specialty building wires improved non-halogen technology is needed to address certain other deficiencies such as conductor corrosion.

The effect of adding flame retardants to polyolefins used as insulating materials is to limit use to low voltage electrical applications. FR polyolefins are not suitable as insulation in voice or data transmission due to limited electrical properties. As a jacket or sheath, where electrical properties are less important, they are widely employed. In both areas FR polyolefins compete with PVC, a lower cost inherently flame retarded material. Neither PVC nor FR polyolefin compound provide for any thermal insulative protection of covered wires or cables.

There are a number of cases where thermal protection for wires is disclosed. In U.S. Pat. No. 4,822,659, to Anderson et.al., a wrap or fire block sheet based on a preformed silicone foam layer, containing aluminum trihydrate to provide fire retardance, is bonded to a non-flammable glass cloth. The disadvantages with this approach, particularly in wire and cable application, are the added process step needed to disperse a mineral filler throughout a reactive mixture and the need to foam and adhere the foam to the supportive substrate. The foam barrier increases the thickness of the construction; a distinct disadvantage in building wire where space available for installation is limited. Moreover, the silicone raw materials and the platinum catalyst add significantly to the overall cost for the application. U.S. Pat. No. 5,202,186, to Williamson, discloses a thermal protective sleeve consisting of a sandwich structure of a laminate of silicone foam provided on both sides of a glass substrate. The deficiencies here are those cited for the foam in U.S. Pat. No. 4,822,659 plus the lack of adequate fire protection, absent the aluminum hydrate filler. U.S. Pat. No. 6,037,546, to Moltine et. al., discloses the use of a heat/ flame resistant layer from a foamed thermoplastic polyvinylidene fluoride (PVDF) material. This technology reports to provide thermal and fire protection but has the disadvantage of adding significant levels of toxic and corrosive acid combustion gases in a fire event. In addition foaming the PVDF, either chemically or by gas injection, adds complexity and cost to the manufactured article. High raw material cost is associated with all fluorocarbon resin systems.

Solid fluorocarbon resins are used in wire and cable application when high cost is not the prohibitive factor, as for example, in plenum cable application. Flourinated ethylene propylene resin (FEP), is used where superior electrical properties, similar to those possessed by polyolefins, are required. FEP is chosen based on the fire resistance despite the disadvantages of high cost, a consistent vagrant supply situation and the potential for toxic combustion gases. These serious disadvantages of FEP create the need for a fire and heat resistant polyolefin system for application in areas demanding superior electrical performance.

Where cost is not the controlling factor, polyvinylidene difluoride ( PVDF ) is the fluorocarbon resin of choice for application as a FR jacket. PVDF provides mechanical and fire protection for cables used in buildings including plenum application. The disadvantages of PVDF are its high cost and the noxious combustion by- products. PVDF decomposes thermally to produce copious quantities of the highly toxic and corrosive acid gas, hydrogen fluoride. This acid is recognized for its corrosive action on metals and glass fibers. Finally, solid PVDF used as a jacket material, will not provide thermal protection to the coated wires or cables.

Polyvinyl chloride ( PVC ) is a low cost inherently flame retardant polymer used in building wires and cables. PVC's are similar in electrical performance to flame retarded polyolefins. The polarity of PVC formulations limits use as an insulating material to low voltage power applications, for example, non-metallic building wire (NM-B) application. Again the poor electrical properties do not prevent use as flame retardant jacket material. Relative to fluorocarbons the lower cost is a very attractive feature. The drawback with PVC jackets is the noxious by-product combustion gases. The first step thermal decomposition of PVC produces substantial quantities (>50% by weight) of the toxic, strongly corrosive acid, hydrogen chloride. Further, on combustion, PVC produces dense black smoke. These features are in sharp contrast with the low smoke and low acid gas produced from the combustion decomposition of non- halogen flame retardant polyolefins. Finally, PVC jackets do not provide thermal protection to coated wires or cables.

In the area of transit application and, in particular the primary wiring used in automobiles, the choice materials to meet requirements are a crosslinked ethylene vinylacetate filled with up to 55 weight percent of silane coated aluminum trihydrate. Crosslinking adds significantly to the complexity and cost to manufacture. Attempts to use non-halogen phosphorous-based intumescent systems have failed due to corrosion of the copper wire conductor by acids produced from hydrolysis of the phosphorous moiety. The industry continues to seek a simple workable non-halogen solution that does not require crosslinking and does not lead to corrosion of the conductor.

It was mentioned above that PVC is a low cost inherently flame retardant insulating material used in certain building wires. One such application is an Underwriter Laboratories designation THHN and THWN. These wire constructions involve a dual layer comprising a 15 mil wire coating of PVC for the insulation and a 4 mil coating of nylon for mechanical protection. On combustion this construction produces copious quantities of dense smoke and toxic and corrosive gases. Again the art seeks a safe and cost effective replacement for this construction.

The dual layer construction of the instant invention is an elegant solution. As the insulation an inner layer of polypropylene or a polypropylene containing magnesium hydroxide filler is used. The outer layer is a polypropylene filled with the necessary level of intumescent material to provide the required level of flame retardance. The thickness of the respective layers is adjusted to meet the test method requirements for the particular applications.

### SUMMARY

In accordance with the present invention a fire resistant and thermal insulative cable comprises an outer protective intumescent layer extruded over a non-halogen flame retardant polyolefin inner layer as a dual layer. This construction is used as a protective jacket over insulated wire or wire cores in buildings and may also be used alone for automotive primary wire and THHN and THWN building wiring. The constructions employing the dual layers offer corrosion protection to conductor wire not found in any previous developments.

### DISCLOSURE OF INVENTION

Accordingly, besides the objects and advantages for the fire resistant and thermal insulative covering described in my above patent, several objects and advantages of the present invention are:
a) to provide a protective coating which prevents flame spread, affords thermal protection and does not produce significant quantities of dense combustion smoke.
b) to provide a protective coating which does not produce toxic and corrosive combustion gases, and prevents corrosion of the conductor.
c) to provide a protective coating that does not require a separate foam manufacturing step.
d) to provide a protective coating that adds a minimum of thickness to a cable construction.
e) to provide a protective coating that permits the use of low cost, high performance but flammable polyolefin insulation compounds and non-halogen flame retardant polyolefin jacket materials in building wire and cable applications.
f) to provide a protective coating that extends the cable circuit integrity thereby adding significantly to the overall safety in buildings and other areas of high personnel occupancy.
g) to provide a dual layer construction to optimize thermal protection or flame spread resistance depending on the relative need in the application.
h) to provide a dual coating for both insulation and flame spread protection in automotive primary wire application.
   Further objects and advantages are to provide low cost, easy to process wires and cables with superior thermal and flame spread performance and a reduction in noxious combustion by-products.

### DESCRIPTION OF THE DRAWINGS

The invention is best understood by reference to the drawings in which:

FIG. 1 is a cross-sectional view of an insulated conductor used in electrical application.

FIG. 2 is an embodiment of the insulated wire of FIG. 1 jacketed with the dual layer of the instant invention.

FIG. 3 is a cross-sectional end view of a cable construction in accordance with the present invention wherein a cable core is enclosed in the dual layer jacket of the instant invention.

FIG. 4 is a cross-sectional end view of a wire conductor covered with the dual layer of the instant invention.

### REFERENCE NUMERAL IN DRAWINGS

10 insulated wire

12 wire conductor

14 solid insulation

15 dual jacketed insulated conductor

16 foamed insulation

18 skin insulation

20 jacket wrapped core cable

22 non-halogen innerjacket/insulation

24 non-halogen intumescent outer layer

25 dual layer coated wire conductor

26 optional wrap

### DETAILED DESCRIPTION OF THE PREFERRED EMBODIMENT

According to the subject invention, a thermal and fire insulative dual layer coating for wire and cable construction in risers, plenums, specialty building wire and in transit applications is provided. One embodiment comprises providing a length of insulated wire with a polymer coating, jacketed with the dual layer comprising a non-halogen (flame retardant) polyolefin resin material as the inner layer and a non-halogen flame and thermal insulating polyolefin based compound containing an intumescent system as the outer layer of the dual jacket. A second embodiment uses the dual layer over a length of electrically conductive metal wire with the inner layer serving as the FR insulation and as a barrier against corrosion and the outer layer as a mechanical and thermal protective jacket.

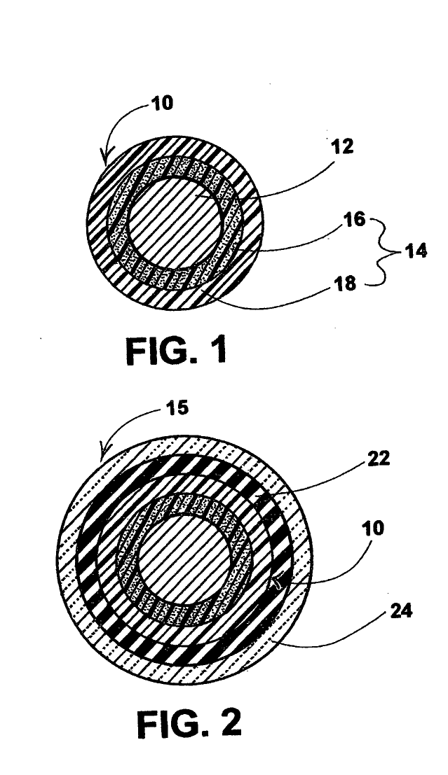

As illustrated in FIG. 1, wires, 12, for electrical conduction can be insulated using solid polymer resins such as polyolefins and fluorinated ethylene propylene, 14, or with a foam resin of the same materials, 16, protected by a thin solid skin, 18. This construction, 10, is used in cables installed in building plenums and risers. Cables used in these applications must pass stringent flame performance requirements detailed as Underwriters Laboratories Subject 1666 for riser cable and Underwriters Laboratories Subject 910 for plenum cable. Beyond a flame resistance requirement plenum cables are also required to satisfy requirements for reduced smoke produced during combustion. To meet these requirements fluorocarbon resins such as polyvinylidene fluoride (PVDF) and low smoke, highly flame retardant polyvinyl chloride are employed. On combustion these materials produce copious quantities of the toxic and corrosive acids, hydrogen fluoride and hydrogen chloride. This serious disadvantage creates the need for a solution to achieve the necessary flame and electrical performance without the drawbacks of the present art.

FIG. 2 presents a preferred embodiment wherein a dual layer protective jacket over an insulated wire is shown, 15. The inner flame retardant jacket, 22, comprises a polyolefin base resin containing a non-halogen flame retardant additive such as aluminum trihydrate or magnesium hydroxide. Preferred base resins used in 22 would include polyolefins such as ethylene vinylacetate (EVA), ethylene ethylacrylate (EEA), linear low density polyethylene (LLDPE), very low density polyethylene (VLDPE), metallocene or single site resins and polypropylenes. The preferred resins are EVA and EEA and the preferred flame retardant additive is magnesium hydroxide. The flame retardance provided by the metal hydrate can be further enhanced by employing Keough et al, U.S. Pat. No. 5,698,323. Therein the added components ZnO and red phosphorous were used in conjunction with magnesium hydroxide to provide for superior flame spread protection. Commercial compounds considered as suitable examples include Dow/Union Carbide DFD-1638 and DFD-1683. The thickness of the inner layer, 22, may vary over a range between 5-50 mils. The outer layer, 24, performs the functions of providing thermal insulation, flame retardance and mechanical and physical protection to the elements within. The layer, 24, comprises a polypropylene base resin containing intumescent filler additives. Representative of suitable instumescents include:

Maxichar Activated Phosphate Blend (Broadview Technologies); Maxichar/Melamine (50/50);

Fyrol MP Melamine Phosphate (Akzo); Fyrol MP/Melamine (50/50);

AC-2 Melamine Pyrophosphate (Alllied Anhydrides & Chemicals); AC-2/Melamine (50/50);

FR Cros 484 Ammonium Polyphosphate (Bundenheim); FR Cros 484/Melamine (50/50);

Phos-Chek P-30 Ammonium Polyphosphate (Monsanto)/Melamine (50/50);

Hostaflam AP 422 (Clariant)/Melamine (50/50);

AC-3 Ethylene Diamine Phosphate (Alllied Anhydrides & Chemicals); AC-3/Melamine (50/50)

The preferred intumescent additives are Maxichar, Fyrol MP and AC-2 alone or admixed with melamine resins.

To summarize thusfar: a two layer thermal and fire protective system is provided wherein the inner layer is a composite of a polyolefin base resin and a metal hydrate as the flame retardant additive. The outer layer is a composite of a polypropylene base resin and an intumescent filler additive that provides thermal and fire, as well as, mechanical protection to underlying components. Based on the generally accepted mechanisms for the two flame retardant systems, below is a proposal for how the two layers act in concert to provide synergism and afford a superior non-halogen flame retarded cable.

The construction shown in FIG. 2 is used to illustrate the process whereby thermal and fire protection is accomplished. In a fire, layer 24 containing the intumescent system rapidly reacts to thermally decompose generating a thermal insulating char in front of the flame propagation. Once formed the char serves to protect the underlying components of the second layer from premature combustion and importantly from any significant heat buildup that otherwise would occur. In this way the non-halogen flame retardant polyolefin layer, 22, is held in reserve to provide flame retardance over a prolonged time frame. The flame retardance in this second layer is provided through an endothermic release and vaporization of bound water from the metal hydrate filler. The longer this release is delayed and the lower the temperature of the total cable composite prior to any combustion the more efficient and effective the construction is against destruction. The thermal protection provided by the intumescent char very significantly increases the effectiveness of the metal hydrate flame retardant polyolefin compound in layer 22.

To fully appreciate the novelty of the two layer invention one need only consider the consequence of combining the intumescent and metal hydrate FR systems into the same composite or layer. Rather than the synergistic interaction detailed above, this combination leads to antagonism and loss of most, if not all, of the flame retardance. The source of this antagonism is believed to result from the following sequence of reactions. Heat first generates strongly acidic phosphorous species and, rather than initiating the steps to produce the insulating char, these species react rapidly to be neutralized by the strong base, magnesium hydroxide. In this way intumescence never occurs and the hydrate FR additive is consumned in a non flame retardant process.

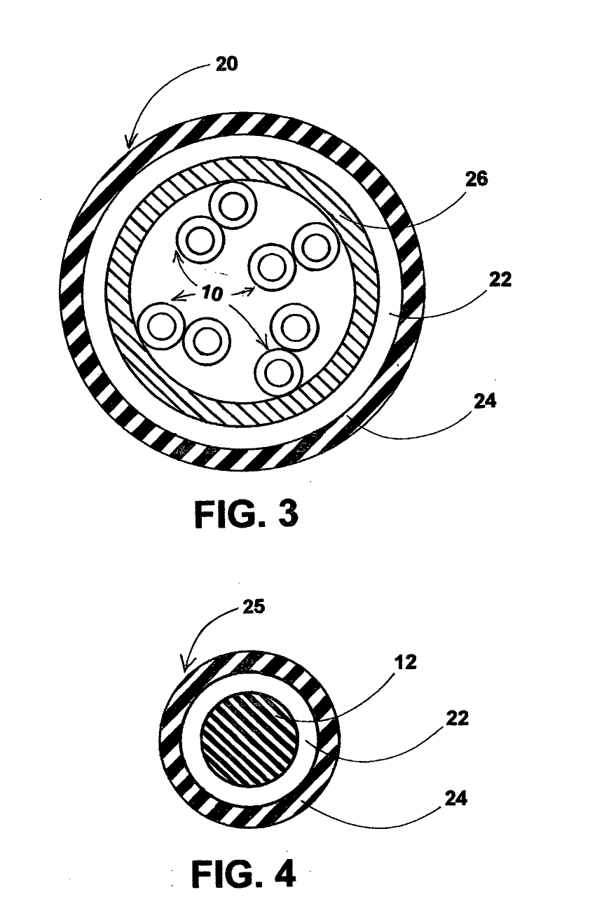

FIG. 3 shows another embodiment, 20, of the invention. This construction is commonly employed in communication cables installed in risers and plenums. Herein a bundled core of paired insulated wires, 10, is optionally covered with a flexible wrap, 26, that may be a woven fiber glass tape, said tape may or may not contain a coating of a ceramic heat and electrical insulating filler such as mica. Alternatively the flexible wrap can be a flame retardant plastic film such as PTFE (Teflon*), polymide (Kapton*), silicones and polyesters (Mylar*). The bundled core, 10, is protected with the dual layer jacket comprising the non-halogen flame retardant polyolefin substrate layer, 22, under the outerjacket, 24, of the intumescent flame and thermal protection system.
*Refer to Trademark designations.

FIG. 2 and FIG. 3 present constructions used where superior electrical flame and thermal insulation is required, as well as, superior low smoke, toxic and corrosive gas release.

FIG. 4 represents a different use for the dual layer construction in wire and cable application. The outer layer, 24, functions as the jacket covering to provide mechanical as well as thermal and fire protection. The inner layer, 22, may provide added fire protection but primarily it serves as the electrical insulation for the construction and mitigates against corrosion to the metal conductor itself. Herein another novel feature of the dual layer approach is revealed. Phosphorous based intumescent FR systems when exposed to ambient moisture are suseptible to a slow hydrolysis reaction producing small quantities of strongly acidic prosphorous species. These acids are known to corrode metals such as the copper and aluminium used as conductors. In the construction of FIG. 4, the layer, 22, between layer 24 and the metal conductor will mitigate against corrosion in two ways. First, the polyolefin of 22 reduces the diffusion of the very polar acids to the conductor thereby sugnificantly nullifying any corrosion. Second, in most cases layer 22 will contain some level of metal hydrate filler, such as magnesium hydroxide. This filler as a strong base will react to completely neutralize any acid entering layer 22. The quantity of acid that is produced through slow hydrolysis is miniscule relative to the thermal degradative process previously discussed. Hence the effectiveness of metal hydrate as a FR additive will not be compromised.

For applications such as automotive primary wiring and building wires layer 22 may be thermoplastic or thermoset. When a thermoplastic is used higher melting polyolefins such as polypropylenes are preferred. Thermoset applications can effectively employ polyethylenes and polyethylene copolymers, such as ethylene vinylacetate. Thermosetting can be accomplished by chemical means using peroxides or using silane modified resins and moisture to cure.

Various conventional additives can be added in conventional amounts to the compositions of the invention. Typicals additives are antioxidants, ultraviolet absorbers, pigments, various fillers including carbon black stabilizers, crosslinking agents , processing aids eg., metal carboxylates, lubricants, and viscosity control agents. Generally, the additives are introduced into the compositions in amounts of about 0.1 to about 5 parts by weight per 100 parts per weight of total composition.

The process to manufacture the cables in FIG. 2, FIG. 3 and FIG. 4 is well known in the art. Each layer can be applied in a separate step using the extrusion principles established for the particular layer. Alternatively for the cables shown in FIG. 2, FIG. 3 and FIG. 4, layers can be applied in a single process step using dual head extrusion technology. This process is widely practiced in wire and cable and is used extensively in the area of power cables wherein dual and triple layers are routinely applied. Semiconductor layers coextruded over power cable insulation is the best example of the technology. The existence of established process technology adds significantly to the value of the dual layer fire and thermal protective construction because factories contain the equipment as well as the expertise.

1-17. (Canceled)

18. A dual layer polymer-based, non-halogen protective sheath for cables comprising:
(i) an outer intumescing solid, non-foamed polymer layer as means for providing thermal, fire, physical and mechanical protection; and
(ii) an inner solid, non-foamed polymer layer as means for providing a second layer of flame protection.

19. The protective sheath defined in claim 18 wherein the outer layer contains a polypropylene or polypropylene copolymer as the base resin.

20. The protective sheath defined in claim 19 wherein the intumescing material of the outer layer is an activated polyphosphate or a melamine phosphate or a melamine pyrophosphate alone or admixed with about an equal quantity of melamine resin.

21. The protective sheath defined in claim 20 wherein the intumescing materials are in about 5 to about 100 parts by weight contained in 100 parts by weight of the polypropylene or polypropylene copolymer resin.

22. The protective sheath defined in claim 18 wherein the outer layer is of a predetermined thickness to provide sufficient thermal protection to the flame retarded inner layer whereby the combination substantially prevents flame spread in cable constructions.

23. The protective sheath defined in claim 18 wherein the inner layer is a non-halogen extrudable composition of
(A) a copolymer of ethylene and an unsaturated ester comonomer of a vinyl carboxylate wherein the carboxylate group has 2 to 5 carbon atoms;
(B) the copolymer is, optionally, modified with an anhydride of an unsaturated aliphatic diacid having 4 to 10 carbon atoms:
(C) the copolymer (A) has an ester content in the range of about 15 to 40 percent based on the weight of the copolymer and a melt index in the range of about 2 to about 25 grams per 10 minutes; and, for each 100 parts by weight of components (A) and about 100 to 250 parts by weight of magnesium hydroxide, coated or coated.

24. The inner layer defined in claim 23 wherein the unsaturated ester comonomer is vinyl acetate.

25. A plenum or riser cable comprising a conductor core and at least one layer surrounding the core comprising the dual layer non-halogen protective sheath defined in claim 18.

26. A dual layer polymer-based, non-halogen coated wire construction comprising:
(i) an intumescing outer solid non-foamed polyolefin layer as means for providing thermal, fire, physical and mechanical protection; and
(ii) an inner polyolefin layer as means for providing electrical insulation and fire and corrosion protection for the construction.

27. The wire construction defined in claim 26 wherein the outer layer is an extrududable composition consisting essentially of;
(a) a polypropylene or polypropylene copolymer
(b) intumescing material that is an activated polyphosphate or a melamine phosphate or a melamine pyrophosphate alone or admixed with about an equal quantity of melamine resin.

28. The wire construction defined in claim 27 wherein the intumescing materials are in about 5 to 100 parts by weight contained in 100 parts by weight of the polypropylene or polypropylene copolymer.

29. The wire construction defined in claim 26 wherein the outer layer is of a predetermined thickness to provide sufficient thermal protection to the flame retarded inner layer whereby the combination substantially reduces flame spread along the construction.

30. The dual layer non-halogen coated wire construction defined in claim 26 wherein the inner insulating layer is formed of a polypropylene or polypropylene copolymer and contains sufficient acid neutralizer to prevent conductor corrosion.

31. The inner insulating layer defined in claim 30 wherein the acid neutralizer is magnesium or calcium hydroxide.

32. The acid neutralizer defined in claim 30 is in about 0.5 to 50 parts by weight contained in 100 parts by weight of polypropylene or polypropylene copolymer.

33. A building wire comprising a metal conductor protected against fire and corrosion by the dual layer defined in claim 26.

34. An automotive primary wire insulation comprising a metal conductor protected against fire and corrosion by the dual layer defined in claim 26.
